(19) United States
(12) Patent Application Publication
(10) Pub. No.: US 2018/0373458 A1
(43) Pub. Date: Dec. 27, 2018

(54) CONTROL METHOD OF ELECTRONIC MODULE IN VEHICLE AND VEHICLE HAVING THE SAME

(71) Applicants: Hyundai Motor Company, Seoul (KR); Kia Motors Corporation, Seoul (KR)

(72) Inventors: Dong Ok Kim, Goyang (KR); Jinhwa Yun, Seoul (KR)

(21) Appl. No.: 15/820,061

(22) Filed: Nov. 21, 2017

(30) Foreign Application Priority Data
Jun. 27, 2017 (KR) 10-2017-0081106

(51) Int. Cl. G06F 3/06; H04L 12/40; G05B 15/02; G06F 13/36

(52) U.S. Cl. CPC G06F 3/0647; H04L 12/40; G05B 15/02; B60R 16/023; G06F 3/0683; G06F 13/36; H04L 2012/40215; G06F 3/0613

(57) ABSTRACT

An in-vehicle communication method enables efficient data management by reducing a controller area network (CAN) message volume without changing a hardware component, in which the communication method is capable of changing data included in the CAN message. To carry out the communication method, a vehicle includes: a storage unit; a communication unit that receives first information including an identifier at an initial time point and second information including the identifier at a time after the initial time point; and a controller that stores the first information in the storage unit and a data field of the second information different from a data field of the first information by comparing the data field of the first information with the data field of the second information.

### CROSS-REFERENCE TO RELATED APPLICATION(S)

This application claims under 35 U.S.C. § 119(a) the benefit of Korean Patent Application No. 10-2017-0081106, filed on Jun. 27, 2017 in the Korean Intellectual Property Office, the entire contents of which are incorporated herein by reference.

### BACKGROUND

### 1. Technical Field

Embodiments of the present disclosure relate to a control method of electronic modules in a vehicle and a vehicle including the same, and more particularly, to controller area network (CAN) data transmission and storage method for communications among electronic modules in a vehicle.

### 2. Description of the Related Art

With recent advancements in vehicle technology, vehicles have been provided with a variety of features for the convenience of users, in addition to basic driving functions.

To this end, vehicles include components or devices that perform various functions, and various electronic modules are provided to control the components and devices.

The electronic modules exchange information with each other via a network and perform various functions therethrough. A controller area network (CAN) data bus used as a network in vehicles refers to a network system used to transmit and control data between the electronic modules. That is, electronic modules perform various functions by exchanging data with each other via the CAN-data bus.

Meanwhile, although the necessity of collecting information on vehicles is increasing, a volume of signals (i.e., amount of data) considerably increases within a short time when the signals received from the vehicle are stored without processing. Thus, extensive research has been conducted into efficient data management in vehicles.

### SUMMARY

Therefore, it is an aspect of the present disclosure to provide an in-vehicle communication method and a vehicle enabling efficient data management by reducing a CAN message volume without changing a hardware component by providing a communication method capable of changing data included in the CAN message.

Additional aspects of the disclosure will be set forth in part in the description which follows and, in part, will be apparent from the description, or may be learned by practice of the disclosure.

In accordance with one aspect of the disclosure, there is provided a vehicle comprising: a storage unit; a communication unit configured to receive first information comprising an identifier at an initial time point and second information comprising the identifier at a time after the initial time point; and a controller configured to store the first information in the storage unit and a data field of the second information different from a data field of the first information by comparing the data field of the first information with the data field of the second information.

The controller may store the identifier of the second information and time point data of the second information in the storage unit.

The controller may determine a state bit corresponding to the second information based on a difference between message data of the first information and message data of the second information, and stores the state bit corresponding to the second information in the storage unit.

The controller may compare message data of the first information with message data of the second information, and stores the message data of the second information in the storage unit when the message data of the second information is different from the message data of the second information.

The controller may store message data of the second information in the storage unit based on the type of the identifier.

The controller may store a part of the second information in the storage unit based on preset storage options regardless of a difference between the data field of the first information and the data field of the second information.

The storage options may be to store at least one of a channel of the second information, a transmission/reception format of the second information, and a length of the second information in the storage unit regardless of a difference between the data field of the first information and the data field of the second information.

The controller may store a time point of the second information and an identifier of the second information in the storage unit regardless of a difference between the data field of the first information and the data field of the second information.

In accordance with one aspect of the disclosure, there is provided a method of controlling an electronic module of a vehicle, the method comprising: receiving first information comprising an identifier at an initial time point and second information comprising the identifier at a time point after the initial time point, storing the first information, comparing a data field of the first information with a data field of the second information, and storing the data field of the second information different from the data field of the first information.

The storing of the data field of the second information different from the data field of the first information may include storing the identifier of the second information and time point data of the second information.

The method further comprising determining a state bit corresponding to the second information based on a difference between message data of the first information and message data of the second information.

The storing of the data field of the second information different from the data field of the first information may include storing the state bit corresponding to the second information.

The storing of the data field of the second information different from the data field of the first information may include: comparing message data of the first information with message data of the second information; and storing the message data of the second information when the message data of the second information is different from the message data of the first information.

The storing of the data field of the second information different from the data field of the first information may be performed by storing the message data of the second information in the storage unit based on the type of the identifier.

The storing of the data field of the second information different from the data field of the first information may include storing a part of the second information based on preset storage options regardless of a difference between the data field of the first information and the data field of the second information.

The storage options may be to store at least one of a channel of the second information, a transmission/reception format of the second information, and a length of the second information regardless of a difference between the data field of the first information and the data field of the second information.

The storing of the data field of the second information different from the data field of the first information may be performed storing the time point of the second information and the identifier of the second information regardless of a difference between the data field of the first information and the data field of the second information.

A non-transitory computer readable medium containing program instructions executed by a processor can include: program instructions that receive first information comprising an identifier at an initial time point and second information comprising the identifier at a time point after the initial time point, program instructions that store the first information in a storage unit, program instructions that compare a data field of the first information with a data field of the second information, and program instructions that store in the storage unit the data field of the second information different from the data field of the first information.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is an exterior view of a vehicle according to an embodiment.

FIG. 2 is an interior view of the vehicle of FIG. 1.

FIG. 3 is a block diagram illustrating an electronic module according to an embodiment.

FIG. 4 is a block diagram illustrating various electronic modules included in a vehicle according to an embodiment.

FIGS. 5A to 5C are diagrams for describing a CAN-data bus.

FIG. 6 is a diagram illustrating a data structure according to an embodiment.

FIG. 7A is a diagram for describing a method of storing data when data is not changed.

FIG. 7B is a diagram for describing a method of storing data when data is changed.

FIGS. 8 and 9 are flowcharts according to an embodiment.

### DETAILED DESCRIPTION

Reference will now be made in detail to the embodiments of the present disclosure, examples of which are illustrated in the accompanying drawings, wherein like reference numerals refer to like elements throughout.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure will be described in detail with reference to the accompanying drawings.

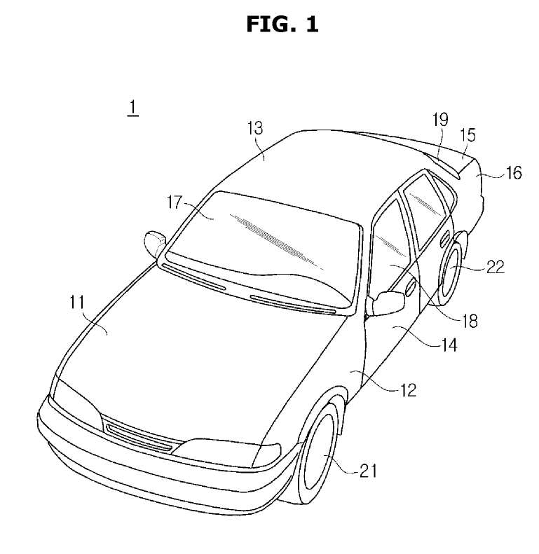

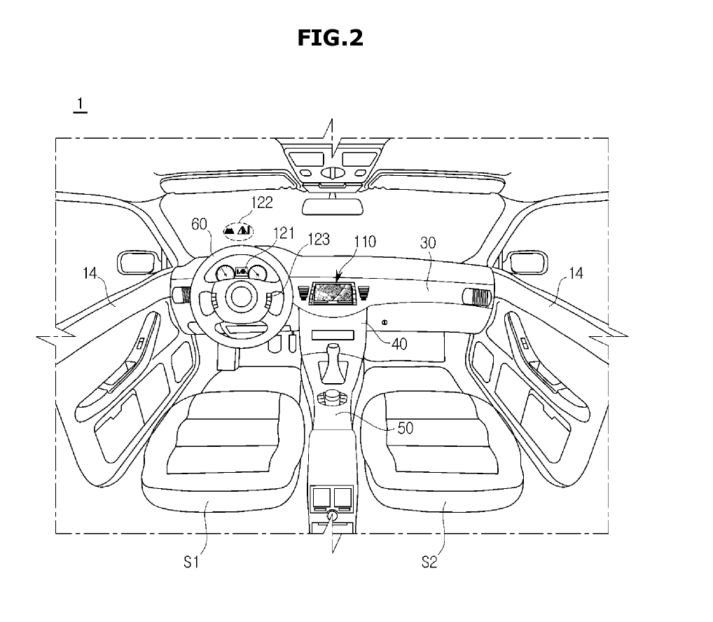

FIG. 1 is an exterior view of a vehicle according to an embodiment. FIG. 2 is an interior view of the vehicle. As illustrated in FIG. 1, a vehicle 1 according to an embodiment includes a body 11 to 16 defining an appearance of the vehicle 1, a chassis (not shown) to support components of the vehicle 1, and wheels 21 and 22 to move the body 11 to 16 and the chassis.

The wheels 21 and 22 include front wheels 21 disposed at front portions of the vehicle and rear wheels 22 disposed at rear portions of the vehicle. The vehicle 1 may move forward or backward by rotation of the wheels 21 and 22.

The body 11 to 16 may include a hood 11, a front fender 12, a roof panel 13, doors 14, a trunk lid 15, a quarter panel 16, and the like.

In addition, a front windshield 17 installed at a front portion of the body 11 to 16, side windows 18 installed at the doors 14, and a rear windshield 19 installed at a rear portion of the body 11 to 16 may be provided on the exterior of the body 11 to 16.

As illustrated in FIG. 2, the interior of the body 11 to 16 may be provided with seats S1 and S2 for a driver and a passenger, a dashboard 30 on which an instrument cluster to control the operation of the vehicle 1 and display driving-related information of the vehicle 1 is disposed, a center fascia 40 provided with a control panel to control accessories included in the vehicle 1, a center console 50 provided with a gear shifter and a parking brake stick, and a steering wheel 60 to control a travelling direction of the vehicle 1.

The seats S1 and S2 allow the driver to sit in a comfortable and stable position and control the vehicle 1 and include a driver's seat S1, a front passenger's seat S2, and back seats (not shown) located in the rear side of the vehicle 1.

The dashboard 30 may be provided with the instrument cluster displaying driving-related information such as a speedometer, a fuel gauge, an automatic transmission selection indicator light, a tachometer, and a trip meter.

The center fascia 40 may be disposed between the driver's seat S1 and the front passenger's seat S2 and provided with a control panel to control an audio device, an air conditioner, and a heater and vents of the air conditioner for adjusting temperature in the body 11 to 16, a cigar jack, and the like.

The center console 50 may be disposed below the center fascia 40 between the driver's seat S1 and the front passenger's seat S2 and provided with a gear stick for transmission and a parking brake stick for parking.

The steering wheel 60 may be attached to the dashboard 30 to be rotatable about a steering shaft and the driver may turn the steering wheel 60 clockwise or counterclockwise to change the traveling direction of the vehicle 1.

The chassis (not shown) may be provided with a power generation apparatus (e.g., engine or motor) to generate power for moving the vehicle 1 by burning fuel, a fuel supply apparatus to supply fuel to the power generation apparatus, a cooling apparatus to cool the heated power generation apparatus, an exhaust apparatus to discharge gas generated by combustion of the fuel, a power transmission apparatus to transmit the power generated by the power generation apparatus to the wheels 21 and 22, a steering apparatus to transmit the traveling direction of the vehicle 1 manipulated by the steering wheel 60 to the wheels 21 and 22, a brake apparatus to stop the rotation of the wheels 21 and 22, and a suspension apparatus to absorb vibrations of the wheels 21 and 22 caused by a road.

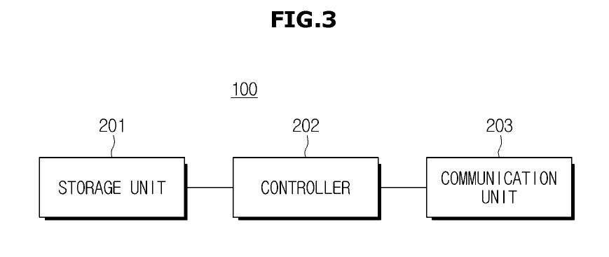

FIG. 3 is a block diagram illustrating an electronic module according to an embodiment.

Referring to FIG. 3, an electronic module 100 may include a controller, a communication unit, and a storage unit.

A communication unit 203 may transmit/receive data to/from various devices disposed in the vehicle via an in-vehicle communication network. For example, the devices may include a display, a telematics unit (TMU) an external amplifier, and a head unit, as well as various devices built into the vehicle 1 without limitation.

The in-vehicle communication network refers to a communication network used for transmission and reception of data among devices in a vehicle. According to an embodiment, the communication unit may exchange data with devices disposed in the vehicle 1 via a controller area network (CAN).

The CAN which will be described hereinafter is a network used in vehicles to provide digital serial communications among various control devices of the vehicle 1 and refers to a communication network providing real-time communications by replacing complicated electrical wiring and relays of electronic parts of the vehicle 1 with a serial communication line, as described herein. However, the in-vehicle communication network is not limited thereto, and the communication unit 203 may also transmit/receive data to/from devices installed in the vehicle 1 via various other communication networks available in the vehicle 1. The communication unit may receive data at different time points. According to the present embodiment, the communication unit may receive data corresponding to first information at an initial time point and second information at a time point after receiving the first information.

The communication unit may also communicate with a terminal device used by the driver and the passenger in addition to the devices inside the vehicle. The terminal device may be implemented using any computer or portable terminal device capable of accessing the device via a network. In this case, examples of the computer may include a notebook computer, desktop, laptop, tablet PC, and slate PC mounted with an Internet or web browser. For example, the portable terminal device may be a wireless communication device that guarantees portability and mobility and include all types of handheld devices such as personal communication system (PCS), global system for mobile communications (GSM), personal digital cellular (PDC), personal handyphone system (PHS), personal digital assistant (PDA), International Mobile Telecommunications-2000 (IMT-2000) terminal, Code Division Multiple Access-2000 (CDMA-2000) terminal, Wideband Code Division Multiple Access (W-CDMA) terminal, Wireless Broadband Internet (WiBro) terminal, and smartphone and wearable devices such as a watch, ring, bracelet, anklet, necklace, glasses, contact lenses, or head-mounted device (HMD).

Meanwhile, data received by the communication unit may include time point when data is received, channel information, identifier ID, whether or not a device receives data, format, data length, message (payload), CRC information, and the like. The above-described information may be expressed in data fields included in the first information and second information.

The controller 202 may determine different data fields between the first information and the second information by comparing the first information with the second information received by the communication unit. For example, if the first information is received at a time point t1 and the second information is received at a time point t2, t1 is expressed in a data field corresponding to the time point of the first information, and t2 is expressed in a data field corresponding to the time point of the second information so that there is a difference in the time point. In this case, the controller may determine that there is a difference in the data field between the first information and the second information.

Meanwhile, when the contents of the data fields are the same as a result of comparison of the data fields between the first information and the second information, the controller does not separately store the data fields of the second information. That is, the data field of the first information may be used in an unchanged part of the data fields where there is no change, so that no data is stored separately.

However, the user may set storage options in advance for storage of data performed by the controller. According to the present embodiment, the controller may store different data fields after comparing the first information with the second information and may also store channel information, transmission/reception information, and length information included in data regardless of the difference therebetween based on the storage options set by the user. The channel information refers to physical classification such as power train, chassis, body, and infotainment. If the vehicle uses Ethernet instead of the CAN network, the transmission/reception information divided into Rx (Ingress) and Tx (Egress) may be stored regardless of the difference therebetween.

On the contrary, the controller may essentially store the identifier and time point data of each piece of information to determine the type of information and identify the information. Since the time points of the first information and the second information are different, all time point data may be stored. However, even when the identifiers of the first information and the second information are the same, the identifiers may be stored.

Also, the controller may compare messages (payloads) of the first information and the second information including the substantial contents. In particular, the controller may compare the message of the first information with that of the second information, and store the message of the second information only when the second information is different from the first information as a result of comparison of messages between the first information and the second information. Even when the message is different, the controller may not store the second information depending on the identifier. For example, the controller may not store information in the storage unit when the information is not required to be stored in case of, for example, a broadcast station name or song information. In this case, the first information and the second information may include identifiers corresponding to the messages.

The message contained in each piece of information includes the actual contents of the information. The controller may assign state bits to the first information initially received by the communication unit and the second information received at a time point after the initial time point, which will be described later.

The controller 202 may include a memory configured to store programs used to perform the operation described above and below and various data related thereto, a processor configured to execute the programs stored in the memory, and a micro controller unit (MCU). In addition, the controller 202 may be integrated into a system on chip (SOC) built into the vehicle 1 and operated by the processor. However, since not only one SOC but also a plurality of SOCs may be provided in the vehicle 1, the embodiment is not limited to the case of being integrated into only one SOC.

The storage unit is configured to allow the controller to control the information received by the communication unit based on the above-described contents.

The storage unit may include at least one type of storage medium selected from a flash memory type, a hard disk type, a multimedia card micro type, a card type memory (e.g., SD or XD memory), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, and optical disk. However, the present disclosure is not limited thereto and the storage unit may also be implemented using any other type well known in the art.

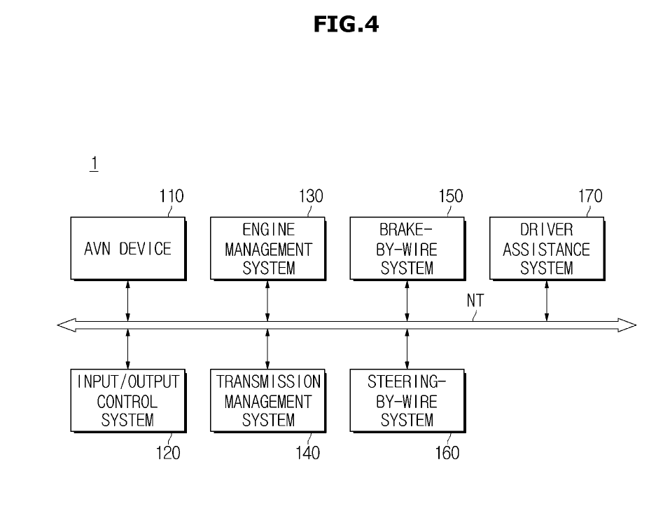

FIG. 4 is a block diagram illustrating various electronic modules included in a vehicle according to an embodiment.

Referring to FIG. 4, the vehicle 1 may include an audio/video/navigation (AVN) device 110, an input/output control system 120, an engine management system (EMS) 130, a transmission management system (TMS) 140, a brake-by-wire system 150, a steering-by-wire system 160, a driver assistance system 170, and the like. The electronic module illustrated in FIG. 4 is examples of electronic modules included in the vehicle 1 and the vehicle 1 may include various other electronic modules.

In addition, various electronic modules 100 included in the vehicle 1 may communicate with each other via a vehicle communication network NT. The vehicle communication network NT may employ communication protocols such as Media Oriented Systems Transport (MOST) offering a bit rate up to 24.5 megabits/second (Mbps), FlexRay offering a bit rate up to 10 Mbps, Controller Area Network (CAN) offering a bit rate of 125 kilobits/second (kbps) to 1 Mbps, Local Interconnect Network (UN) offering a bit rate of 20 kbps, and Ethernet offering a bit rate up to 10 Mbps. The vehicle communication network NT may use not only a single communication protocol such as MOST, FlexRay, CAN, and LIN but also a plurality of communication protocols.

The AVN device 110 is a device configured to output music or image in accordance with a control command of the driver. Particularly, the AVN device 110 may play a music or video or guide a route to a destination in accordance with the control command of the driver.

The input/output control system 120 receives the control command of the driver via a button and displays information corresponding to the control command of the driver. The input/output control system 120 may include a cluster display 121 disposed at the dashboard 30 and displaying an image, a head-up display 122 configured to project an image onto the front windshield 17, and a button module 123 installed at the steering wheel 60.

The cluster display 121 is disposed at the dashboard 30 and displays an image. Particularly, since the cluster display 121 is provided adjacent to the front windshield 17, the driver may acquire information on the operation of the vehicle 1, road information, or a travel route with a low deviation in a driver's gaze from a road ahead. The cluster display 121 may be implemented using a liquid crystal display (LCD) panel or an organic light emitting diode (OLED) panel.

The head-up display 122 may project an image onto the front windshield 17. An image projected onto the front windshield 17 by the head-up display 122 may include information on the operation of the vehicle 1, road information, or the travel route.

The engine management system 130 performs fuel injection control, fuel efficiency feedback control, lean burn control, ignition timing control, and idling control. The engine management system 130 may be a single device or a plurality of devices connected via a communication network.

The transmission management system 140 performs gear shifting control, damper clutch control, pressure control during On/Off operation of frictional clutch, and engine torque control during shifting of gears. The transmission management system 140 may be a single device or a plurality of devices connected via a communication network.

The brake-by-wire system 150 may control a brake of the vehicle 1 and include an anti-lock brake system (ABS) or the like.

The steering-by-wire system 160 assists steering manipulation of the driver by reducing a steering force during low-speed driving or packing and by increasing the steering force during high-speed driving.

The driver assistance system 170 may assist driving of the vehicle 1 and perform forward collision avoidance, lane departure warning, dead zone monitoring, rear monitoring, and the like.

The driver assistance system 170 may include a plurality of devices connected via a communication network. For example, the driver assistance system 170 may include a forward collision warning system (FWC) to avoid a crash with a vehicle ahead by sensing vehicles traveling ahead in the same direction in the same lane, an advanced emergency braking system (AEBS) to automatically activate a braking system to reduce impact in case of an inevitable collision with a vehicle ahead, an adaptive cruise control (ACC) to automatically increase or decrease a vehicle speed in accordance with a speed of a vehicle ahead by sensing vehicles traveling ahead in the same direction in the same lane, a land departure warning system (LDWS) to prevent the vehicle from moving out of a current lane, a lane keeping assist system (LKAS) to support the driver to stay within its lane upon determination of lane departure of the vehicle, a blind spot detection (BSD) to provide the driver with information on vehicles located in dead zones, and a rear-end collision warning system (RCW) to avoid collision with a vehicle behind by sensing vehicles traveling behind in the same direction in the same lane.

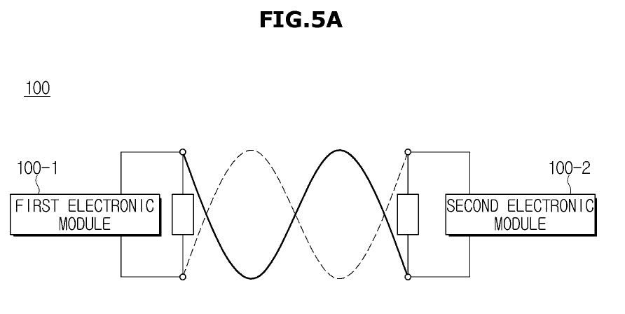

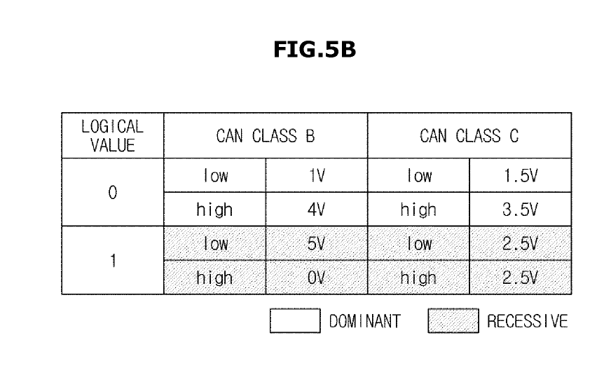

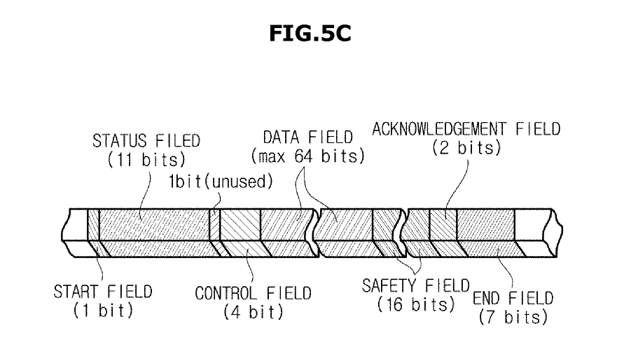

FIGS. 5A to 5C are diagrams for describing a CAN-data bus.

As described above, the plurality of electronic modules installed in the vehicle 1 may use a CAN network to exchange data. In this regard, CAN may also be referred to as Controller Area Network or CAN-data bus.

FIG. 5A is a schematic view illustrating the configuration of a CAN-data bus. Referring to FIG. 5A, a first electronic module 100-1 and a second electronic module 100-2 may be included in at least two electronic devices respectively. In the CAN network, data is transmitted via a pair of two data wires twisted or shielded. The CAN network operates according to a multi-master principle in which multiple ECUs serve as masters in a master/slave system.

The CAN-data bus falls under class B and class C categories. Class B provides a maximum data transmission rate of about 125 kBd, and class C provides a maximum data transmission rate of about 1 MBd.

In addition, a CAN-data bus system transmits data by using a pair of wires. The CAN class B has suitability against single line, while the CAN class C does not have suitability against single line.

Here, the suitability against single line refers to a phenomenon in which even when one wire is cut or short-circuited in a CAN-data bus system, the remaining other wire maintains the communication ability thereof precisely. However, when the CAN-data bus system changes to a single line mode, interference resistance is no longer guaranteed. That is, in some cases, malfunctioning may be caused.

Referring back to FIG. 5A, the CAN-data bus system may include two nodes, two terminal resistors, a CAN-high wire, and a CAN-low wire.

Specifically, the nodes refer to a plurality of stations constituting a CAN-data bus system and may indicate the first electronic module 100-1 and the second electronic module 100-2 in the present embodiment. That is, the nodes may be include in at least two electronic modules selected from the above-described electronic modules.

That is, FIG. 5A illustrates the first electronic module 100-1 and the second electronic module 100-2 as two nodes. The first electronic module 100-1 and second electronic module 100-2 may exchange data via a communication method to be described later.

Meanwhile, bus wires include a CAN-high wire and a CAN-low wire. When the CAN-high wire becomes dominant by a transceiver of a node, a voltage of this wire increases. Simultaneously, a voltage of the CAN-low wire decreases. In this case, a logical value is ‘0’. That is, the two wires are twisted or shielded by wire mesh.

That is, a magnetic field generated in the two CAN-wires is offset since voltages change in opposite directions by switching. Thus, the two wires are electrically neutral to the outside and do not cause any external interference. That is, resistance against interference is guaranteed.

Referring to FIG. 5B, the above-described logical values may be classified according to CAN classes. For example, when the CAN-low wire is 1 V and the CAN-high wire is 4 V in the CAN class B, the logical value may be 0. On the contrary, when the CAN-low wire is 5 V and the CAN-high wire is 0 V in the CAN class C, the logical value may be 1. However, these voltages may vary without limitation.

Referring back to FIG. 5A, the terminal resistor connects the CAN-high wire with the CAN-low wire. This prevents reflection from occurring in the CAN-bus wire.

A CAN-bus wire with no terminal resistor, particularly, functional failures may be caused in the CAN class C. In the CAN class C, the terminal resistor may be tested at a contact point of the CAN-wire using a resistance meter.

Meanwhile, CAN operates according to the multi-master principle as described above. The multi-master principle refers to multiple communication instead of point-to-point communication and indicates a system in which multiple nodes are connected with each other rather than being connected via a central node.

Thus, each node, i.e., electronic module, may transmit a message via a CAN-bus wire unless information is being transmitted/received via the CAN-bus wire.

In this case, when a plurality of electronic modules desire to send messages simultaneously, an important message is transmitted first by arbitration. That is, arbitration refers to controlling of access to the CAN-data bus wire when a plurality of electronic modules 100 desire to transmit messages simultaneously.

Thus, importance or priority of a message required for arbitration is defined by the identifier ID. A lower identifier ID may have a higher priority.

FIG. 5C is a diagram for describing a structure of data used in a CAN network. Referring to FIG. 5C, data is generally composed of a start field, a status field, a control field, a safety field, an acknowledgement field, and the like.

The start field (11 bits) indicates the beginning of a message and notifies the node of the start of message transmission. That is, the electronic module 100 is synchronized when the start field is transmitted.

The status field (11 bits) includes a message identifier (message logical symbol). That is, the nodes identify the contents of the message based on the identifier ID. Also, determining of a transmitter to send a message first, i.e., arbitration, may also be executed based on the identifier ID.

The control field, the safety field, and the acknowledgement field are used to ensure data transmission. A message transmitting node uses the acknowledgement field to confirm whether the message is correctly read by a message receiving node.

That is, if there is no acknowledgement, the message is repeatedly sent. If no acknowledgement is received from a receiving node even after several attempts, the transmitting node stops sending of the message. Thus, even when one node fails, the failure of the whole CAN-data bus system is prevented. The control field has a length of 6 bits, the safety field has a length of 16 bits, and the acknowledgement-field has a length of 2 bits.

An end field (7 bits) indicates the end of the message and allows the CAN-data bus to be in a free standby state for a next message.

Finally, the data field (max. 64 bits) includes useful data of the message as well as the substantial data transmitted by each node.

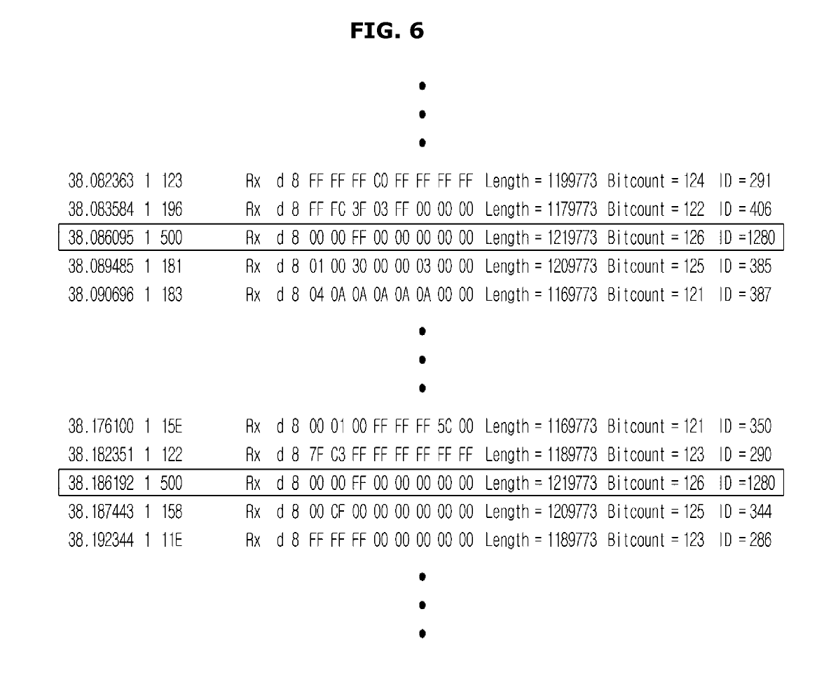

FIG. 6 is a diagram illustrating a data structure according to an embodiment.

Referring to FIG. 6, data illustrated in FIG. 6 may include a time point when data per packet is received, channel information, Hex identifier transmission/reception information, format, message length, payload, length of information, CRC information, decimal identifier, and the like.

In FIG. 6, the communication unit receives first information at ‘38.086095’ and second information at ‘38.186192’. Both the first information and the second information include the same identifier ID of ‘1280’. Both the first information and the second information illustrated in FIG. 6 include the contents of ‘00 00 FF 00 00 00 00’. In such a case illustrated in FIG. 6, the controller may determine that there is no difference in the message since the messages include the same contents and may not store the message of the second information in the storage unit. However, since the time point of the second information is ‘38.186192’ different from the time point ‘38.086095’ of the first information, the controller may store data on the time point. In addition, the controller may not store changed data since there is no change in the data between the first information and the second information except for the time point.

When the user sets a part of data of information as an essential storage element, the controller may store data of the information regardless of the change in data.

For example, when the user sets the identifier of information as the essential storage element, the controller may store data even when the data is not changed. In FIG. 6, since the identifier of both information corresponds to ‘1280’, the controller may store ‘1280’ as the identifier corresponding to the first information and the second information in the storage unit.

Meanwhile, when the user presets storage options, the controller may store data included in each piece of information regardless of change in data. For example, when the user sets storage options of storing transmission/reception information in advance, the controller may store RX (Ingress) of each piece of information to correspond to the information. However, the information illustrated in FIG. 6 is merely an example for describing the operation according to the present disclosure and there are no limitations on formats and contents of information and data.

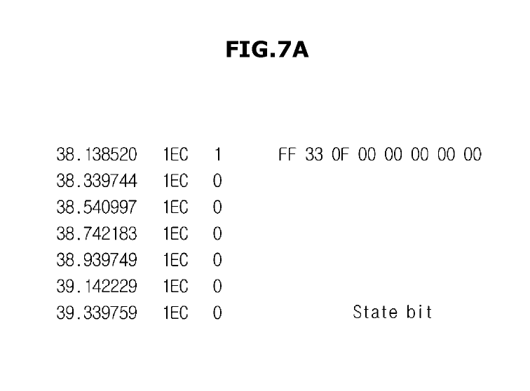

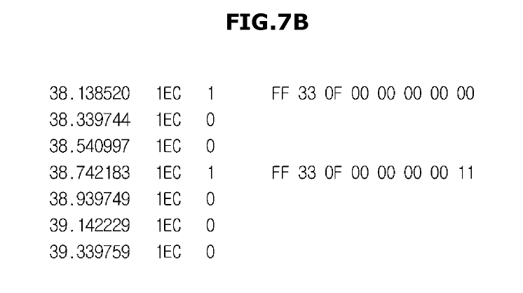

FIG. 7A is a diagram for describing a method of storing data when data is not changed. Referring to FIG. 7A, a part of information received by the communication unit is illustrated. At an initial time point ‘38.138520’, the communication unit receives first information including a message of ‘FF 33 OF 00 00 00 00 00’ and information received after the first information includes the same message. The controller may assign a state bit corresponding to each piece of information to the message received by the communication unit and store the state bit corresponding to the information. The controller may assign a state bit ‘1’ to information initially received by the communication unit, i.e., the first information. The controller may store the message of the first information regardless of a change in the messages of subsequent information. Meanwhile, if there is no change in the message of the information received after the first information, the controller assigns a state bit of ‘0’ to each piece of information and store the state bit in the storage unit to correspond to the information. In this case, if the user sets the time point and the identifier as essential storage elements, the controller may store data corresponding thereto in the storage unit regardless of a change thereof.

FIG. 7B is a diagram for describing a method of storing data when data is changed.

Referring to FIG. 7B, although data initially received by the communication unit is the same as that of FIG. 7A, message data of second information received at a time point ‘38.742183’ is different from that of the first information. That is, the message of the time point ‘38.138520’ is ‘FF 33 OF 00 00 00 00 00’, and the message of the time point ‘38.7422183’ is ‘FF 33 OF 00 00 00 00 11’. The controller determines that the first information is different from the second information by comparing the message at the time point ‘38.138520’ from the message at the time point ‘38.7422183’, assigns a state bit ‘1’ to the second information, and store the state bit to correspond to the second information, in this case, together with the message ‘FF 33 OF 00 00 00 00 11’ of the second information.

Meanwhile, in this case, the controller may not store the message either in case where storage thereof is not necessary by judging the identifier corresponding to each piece of information. For example, when the controller determines that the first information and the second information are names of broadcast stations, icons, song information, telephone numbers, names, or navigation information based on the identifier, which may only be recognized by the user without storing the information in the storage. Thus, even when the message is changed, the controller may not store the information.

Information illustrated in FIGS. 7A and 7B are merely examples for describing the operation of the present disclosure and the format of the state bit assigned to each piece of information by the controller is not limited.

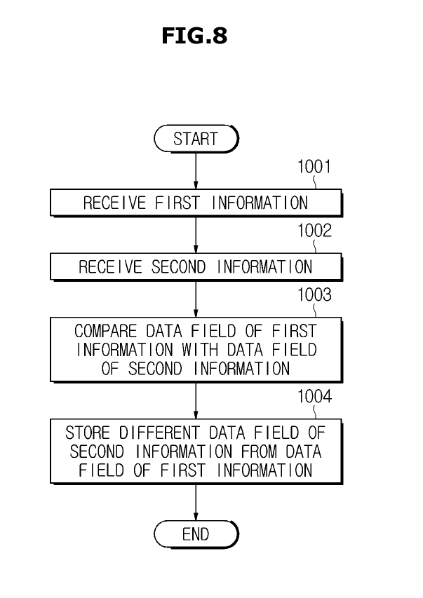

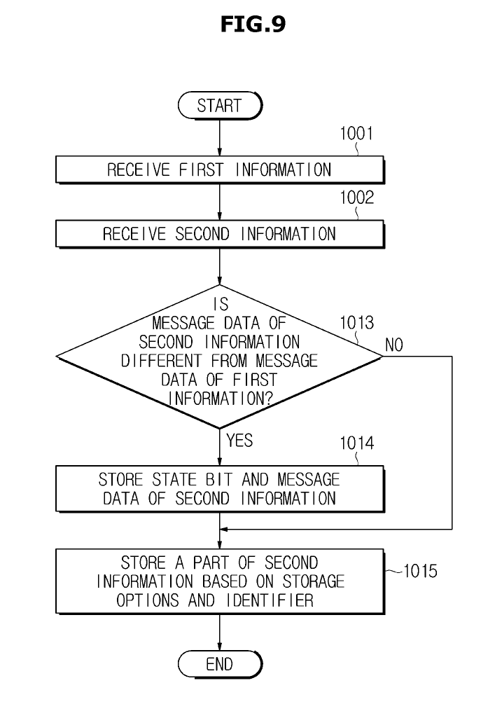

FIGS. 8 and 9 are flowcharts according to an embodiment.

Referring to FIG. 8, when the communication unit initially receives first information (step 1001) and then receives second information (step 1002), the controller may compare a data field of the first information with that of the second information (step 1003). The controller may store a different data field in the storage unit by comparing the data field of the first information with that of the second information (step 1004). Even when a part of the data field of the first information is the same as that of the second information, the controller may store each piece of information in the storage regardless of a difference of the data field between the first information and the second information in the case where the user sets the data field as an essential storage element in advance.

Referring to FIG. 9, the communication unit may receive first information and second information and the controller may compare message data of the first information with message data of the second information in the same manner as in FIG. 8 (step 1013). When the message data is different, the controller may determine a state bit and store the message data and the state bit of the second information to correspond to the second information (step 1014). In addition, the controller may not store changed data or store unchanged data based on storage options set by the user and the type of the identifier (step 1015). In addition, even when the message data of the first information is the same as that of the second information, the controller may store a part of the second information based on storage options and identifiers set by the user in advance (step 1015).

Meanwhile, the aforementioned embodiments may be embodied in the form of a recording medium storing instructions executable by a computer. The instructions may be stored in the form of program codes and perform the operation of the disclosed embodiments by creating a program module when executed by a processor. The recording medium may be embodied as a computer readable recording medium.

The computer readable recording medium includes all types of recording media that store instructions readable by a computer such as read only memory (ROM), random access memory (RAM), magnetic tape, magnetic disc, flash memory, and optical data storage device.

As is apparent from the above description, according to an in-vehicle communication method and a vehicle according to the present disclosure, data may be efficiently managed by reducing a volume of a CAN message without changing a hardware component by providing a communication method of changing data included in the CAN message.

Although a few embodiments of the present disclosure have been shown and described, it would be appreciated by those skilled in the art that changes may be made in these embodiments without departing from the principles and spirit of the disclosure, the scope of which is defined in the d and their equivalents.

What is claimed is:

1. A vehicle comprising:
a storage unit;
a communication unit configured to receive first information comprising an identifier at an initial time point and second information comprising the identifier at a time after the initial time point; and
a controller configured to store the first information in the storage unit and a data field of the second information different from a data field of the first information by comparing the data field of the first information with the data field of the second information.

2. The vehicle according to claim 1, wherein the controller stores the identifier of the second information and time point data of the second information in the storage unit.

3. The vehicle according to claim 1, wherein the controller determines a state bit corresponding to the second information based on a difference between message data of the first information and message data of the second information, and stores the state bit corresponding to the second information in the storage unit.

4. The vehicle according to claim 1, wherein the controller compares message data of the first information with message data of the second information, and stores the message data of the second information in the storage unit when the message data of the second information is different from the message data of the second information.

5. The vehicle according to claim 4, wherein the controller stores the message data of the second information in the storage unit based on a type of the identifier.

6. The vehicle according to claim 1, wherein the controller stores a part of the second information in the storage unit based on preset storage options regardless of a difference between the data field of the first information and the data field of the second information.

7. The vehicle according to claim 6, wherein the storage options are to store at least one of a channel of the second information, a transmission/reception format of the second information, and a length of the second information in the storage unit regardless of the difference between the data field of the first information and the data field of the second information.

8. The vehicle according to claim 1, wherein the controller stores a time point of the second information and an identifier of the second information in the storage unit regardless of a difference between the data field of the first information and the data field of the second information.

9. A method of controlling an electronic module of a vehicle, the method comprising:
receiving, by a communication unit, first information comprising an identifier at an initial time point and second information comprising the identifier at a time point after the initial time point,
storing the first information in a storage unit,
comparing, by a controller, a data field of the first information with a data field of the second information, and
storing in the storage unit the data field of the second information different from the data field of the first information.

10. The method according to claim 9, wherein storing the data field of the second information different from the data field of the first information comprises storing the identifier of the second information and time point data of the second information.

11. The method according to claim 9, further comprising determining a state bit corresponding to the second information based on a difference between message data of the first information and message data of the second information,
wherein storing the data field of the second information different from the data field of the first information comprises storing the state bit corresponding to the second information.

12. The method according to claim 9, wherein storing the data field of the second information different from the data field of the first information comprises:
comparing message data of the first information with message data of the second information; and
storing the message data of the second information when the message data of the second information is different from the message data of the first information.

13. The method according to claim 12, wherein storing the data field of the second information different from the data field of the first information is performed by storing the message data of the second information in the storage unit based on the type of the identifier.

14. The method according to claim 9, wherein storing the data field of the second information different from the data field of the first information comprises storing a part of the second information based on preset storage options regardless of a difference between the data field of the first information and the data field of the second information.

15. The method according to claim 14, wherein the storage options are to store at least one of a channel of the second information, a transmission/reception format of the second information, and a length of the second information regardless of the difference between the data field of the first information and the data field of the second information.

16. The method according to claim 9, wherein storing the data field of the second information different from the data field of the first information is performed by storing the time point of the second information and the identifier of the second information regardless of a difference between the data field of the first information and the data field of the second information.

17. A non-transitory computer readable medium containing program instructions executed by a processor, the computer readable medium comprising:
program instructions that receive first information comprising an identifier at an initial time point and second information comprising the identifier at a time point after the initial time point,
program instructions that store the first information in a storage unit,
program instructions that compare a data field of the first information with a data field of the second information, and
program instructions that store in the storage unit the data field of the second information different from the data field of the first information.
